(19) United States
(12) Patent Application Publication
(10) Pub. No.: US 2015/0233175 A1
(43) Pub. Date: Aug. 20, 2015

(54) Door Seal

(71) Applicant: RBP Associates Limited, Hayling Island (GB)

(72) Inventor: Ronald Brian Parker, Hampshire (GB)

(21) Appl. No.: 14/425,270

(22) PCT Filed: Aug. 30, 2013
(86) PCT No.: PCT/GB2013/000365

§ 371 Date: Mar. 2, 2015

(30) Foreign Application Priority Data
Aug. 30, 2012 (GB) 1215433.2

(51) Int. Cl. E06B 7/215; E06B 7/18; E06B 7/20; E06B 7/21

(52) U.S. Cl. CPC E06B 7/215; E06B 7/21; E06B 7/18; E06B 7/20

(57) ABSTRACT

A sealing assembly is disclosed for a hinged door which is pivotable over a door threshold when closed. The sealing assembly includes a plurality of elements located within a channel positionable adjacent an edge of the door. The elements include an actuator responsive to closing of the door, the actuator having at least one connector rod extending along the channel and being movable longitudinally within the channel in response to the door closing. The or each rod is connected to at least one pivotable arm comprising rigid sections divided by flexible joints, the other end of the arm being connected to a sealing member. The or each arm is flexible such that as the or each connector rod moves along the channel, part of the arm flexes vertically thereby imparting and maintaining vertical pressure on the sealing member during use.

### CROSS-REFERENCE TO RELATED APPLICATIONS

This application is a Section 371 National Stage Application of International Application No. PCT/GB2013/000365, filed Aug. 30, 2013 the content of which is incorporated herein by reference in its entirety, and published as WO 2014/033424 on Mar. 6, 2014, in English.

### FIELD OF THE DISCLOSURE

The present invention relates to a door seal and more especially to an improved automatic door seal that acts to seal the gap between the door and its threshold on closure of the door.

### BACKGROUND OF THE DISCLOSURE

An automatic drop-down door seal developed by the Applicant is disclosed in WO2012/032295. The present invention relates to improvements to the door seal disclosed therein and specifically to provide an improved mechanism to impart a continual vertical pressure on the seal housing during use to retain the seal firmly against the adjacent surface in use.

### SUMMARY

A first aspect of the invention provides a sealing assembly for a hinged door which is pivotable over a door threshold when closed, the sealing assembly comprising a plurality of elements located within a channel positionable adjacent an edge of the door, the elements comprising an actuator responsive to closing of the door, the actuator comprising at least one connector rod extending along the channel and being movable longitudinally within the channel in response to the door closing, the or each rod being connected to at least one pivotable arm comprising rigid sections divided by flexible joints, the other end of the arm being connected to a sealing member, the or each arm being flexible such that as the or each connector rod moves along the channel part of the arm flexes vertically thereby imparting and maintaining vertical pressure on the sealing member during use.

The or each arm may comprise at least one rigid section that comprises a recessed groove shaped so as to receive and retain a curved connector rod, which rod extends beyond the arm and is connected to a second arm.

The connector rod may be connected to the second arm by means of a first connector block which is connected to a further connector rod which is attached to the second arm.

The assembly may further comprise a spring member that is connected to the sealing member at one part thereof and to a second connector block at a second part thereof, which second connector block is fixed in position within the channel, the spring member being configured to pull or push the sealing member back when the actuator is deactivated.

The spring member may be a leaf-type spring member, substantially planar in profile.

The second connector block may comprise a recessed groove through which the connector rod passes between the first and second arms.

The or each arm may comprise first, second and third rigid sections divided by first and second flexible joints, the first rigid section being connected to the actuator and the third rigid section being connected to the sealing member.

Each rigid section of the arm may be formed of polypropylene.

The or each flexible section of the arm may be formed of TPE.

The or each flexible TPE section may be selected so as to melt in the presence of heat associated with a fire so as to substantially fuse and fix the arm in its current state.

A second aspect of the invention provides a sealing assembly for a hinged door which is pivotable over a door threshold when closed, the sealing assembly comprising: a plurality of elements located within a channel positionable adjacent an edge of the door, the elements comprising an actuator which mechanically moves responsive to closing of the door, the actuator comprising a first connector rod extending along the channel and being movable longitudinally within the channel, the first connector rod being connected to a drop arm comprising first, second and third substantially rigid sections divided by first and second flexible joints, the first rigid section being connected to the first connector rod and the third rigid section being connected to a sealing member, the drop arm being configured to flex at one or both flexible joint(s) as the first connector rod moves along the channel in order to impart and maintain a vertical force on the sealing member in use, and wherein a spring member is provided which is connected to the sealing member at one part thereof and to a fixed connector block within the channel at another part thereof in such a way as to pull/push the sealing member backwards into the channel when the actuator is deactivated.

A further aspect of the invention provides a sealing assembly for a hinged door which is pivotable over a door threshold when closed, the sealing assembly comprising a plurality of elements located within a channel positionable adjacent an edge of the door, the elements comprising an actuator responsive to closing of the door, the actuator comprising at least one connector rod extending along the channel and being movable longitudinally within the channel in response to the door closing, the or each rod being connected to at least one pivotable arm comprising rigid sections divided by flexible joints, the other end of the arm being connected to a sealing member, the or each arm being flexible as the or each connector rod moves along the channel to a position whereby the part of the arm flexes vertically thereby imparting and maintaining vertical pressure on the sealing member during use.

### BRIEF DESCRIPTION OF THE DRAWINGS

Embodiments of the invention will now be described with reference to the accompanying figures in which:

FIG. 1 is a perspective view of a door seal in accordance with the invention;

FIG. 2 is a side section view of the assembly of FIG. 1;

FIG. 3 is side sectional view of a cap nut of the spring assembly of FIG. 1;

FIG. 4 is an end sectional view of the cap nut of FIG. 3;

FIG. 5 is a perspective view of a drop arm of the spring assembly of FIG. 1;

FIG. 6 is perspective view of the drop arm of FIG. 5 with a threaded push rod attached thereto;

FIG. 7 is a perspective view of lead rod to connect connector rods within the assembly of FIG. 1;

FIG. 8 is a side cross section view of the drop arm and lead rod in connection;

FIG. 9 is a side view of a threaded connector rod of the assembly of FIG. 1;

FIG. 10 is a perspective view of the spring part of the assembly of FIG. 1;

FIG. 11 is a perspective view of a connector block for connector rods of the assembly of FIG. 1;

FIG. 12 is a perspective view of a connector rod;

FIG. 13 is an end sectional view of the door seal assembly of FIG. 1;

FIG. 14 is an end sectional view of the casing of the seal mechanism of FIG. 13;

FIG. 15 is an end sectional view of drop bar of the seal mechanism of FIG. 13;

FIG. 16 is an end sectional view of a seal insert of the seal mechanism of FIG. 13; and

FIG. 17 is an exploded view of a second embodiment door seal in accordance with the invention.

### DETAILED DESCRIPTION OF ILLUSTRATIVE EMBODIMENTS

The main elements of a drop-down seal are shown and described in WO2012/032295, corresponding to U.S. Pat. No. 8,925,250, the contents of which are hereby incorporated by reference.

The foregoing description will only discuss the improvements to such a system.

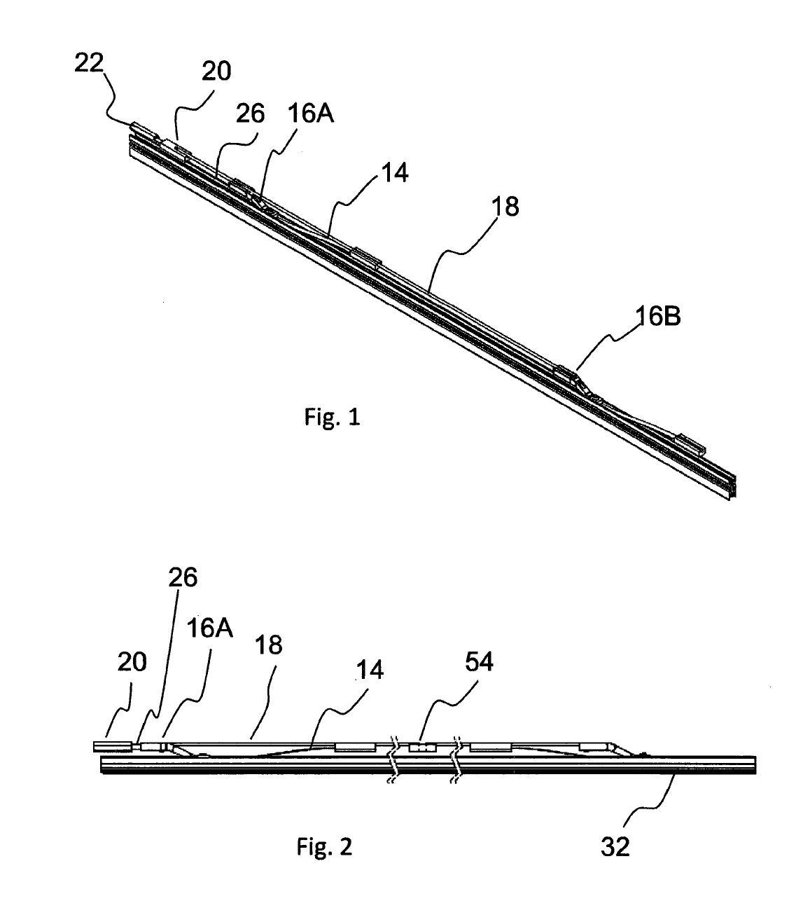

FIGS. 1 and 2 show a door seal constructed in accordance with a first embodiment of the invention.

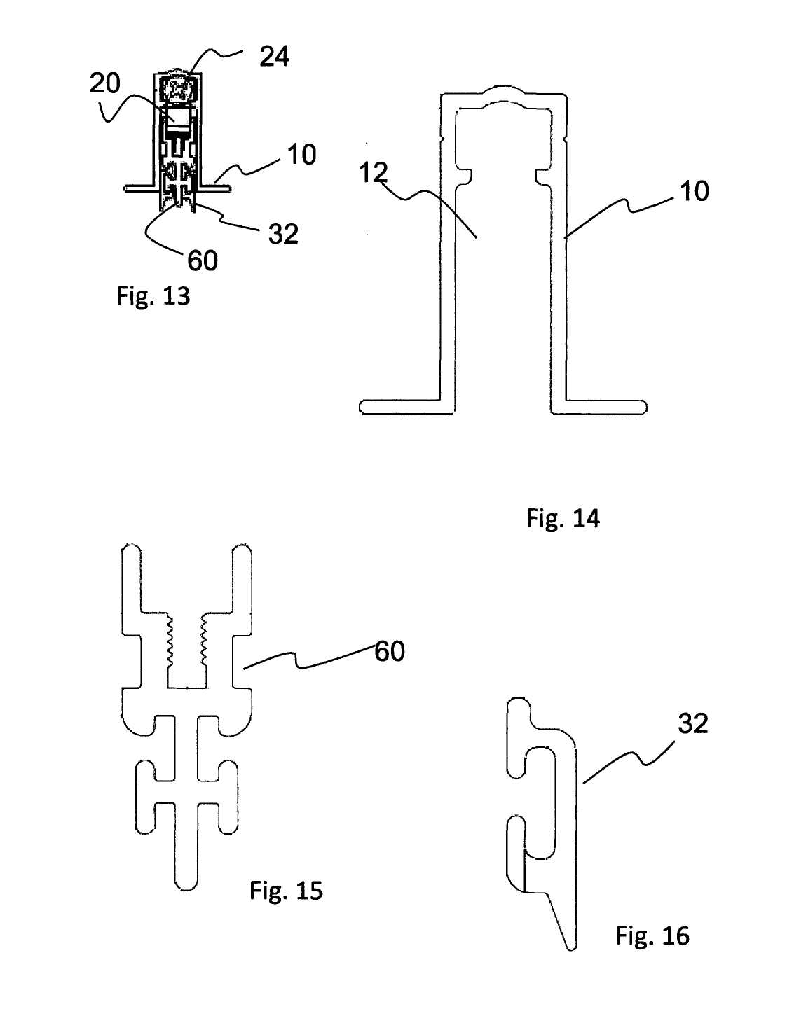

The seal mechanism comprises a main housing 10 (see FIGS. 13 and 14) which is locatable on the edge of a door (not shown) or which may be located within a recess formed in the edge of a door.

It has been found, for reasons explained later, that the seal mechanism is suitable for location on the top, as well as the bottom, of a door (as is traditional) or within a recess formed in the top or bottom of the door.

The main housing 10 may alternatively be fixed to the back of the door bottom or top.

The housing 10 is formed as an inverted U-shaped section and defines a longitudinal channel 12.

Referring to FIGS. 1 and 2, extending through the housing 10 is a spring mechanism designed to impart a vertical force to a sealing member 32 on depression of an actuation button 22 that occurs when a door carrying the seal mechanism is closed.

The spring mechanism comprises an assembly of spring members 14, drop arms 16 (first and second drop arms 16A, 16B are shown here) and connecting rods 18. The term “drop down” has been used throughout the description for convenience and ease of understanding as it is anticipated that the most common use will be in respect of sealing at the bottom of the door. No connotation should be implied by the term “drop” as the embodiment may be used in such a way that the arm extends upward in use.

Referring to FIG. 1 and FIG. 13, a first slide block 20 is located at one end of the housing 10. The block 20 is connected to the actuator button 22 which activates when the door closes, to slide the block 20 along the channel 12.

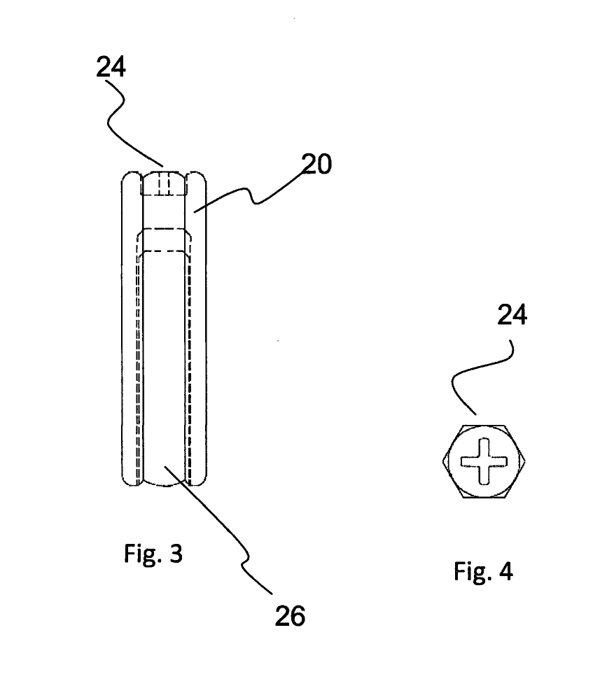

A longitudinal cross section of the slide block 20 can be seen in FIG. 3. The slide block 20 is connected to the actuator button 22 via an adjustable hexagonal cap nut 24, shown from one end in FIG. 4.

The other end of the block 20, remote from the actuator button, is attached via a plunger rod 26 to the first drop arm 16A.

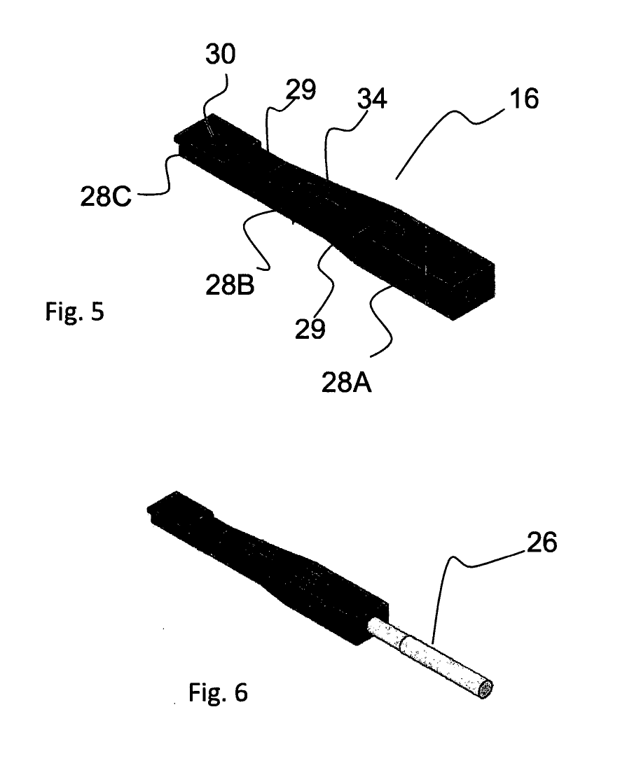

The first drop arm 16A is shown more clearly in FIGS. 5 and 6 (FIG. 6 showing the plunger rod 26 connected to the arm 16). The arm 16 comprises three main sections 28 made from rigid polypropylene separated by sections 29 made from flexible Thermoplastic Elastomer (TPE) to provide a rigid arm with, in this case, two flexible joints 29.

The first rigid section 28A of the arm 16 includes an end-aperture to receive one end of the plunger rod 26 (to allow movement to be imparted to the arm 16). The third section 28C of the arm 16 has an aperture 30 to receive fastening means for securing that end 28C of the arm 16 to a sealing member 32 of the assembly.

A recessed groove 34 extends through part of the first and second rigid parts 28A,B to receive a lead rod 36.

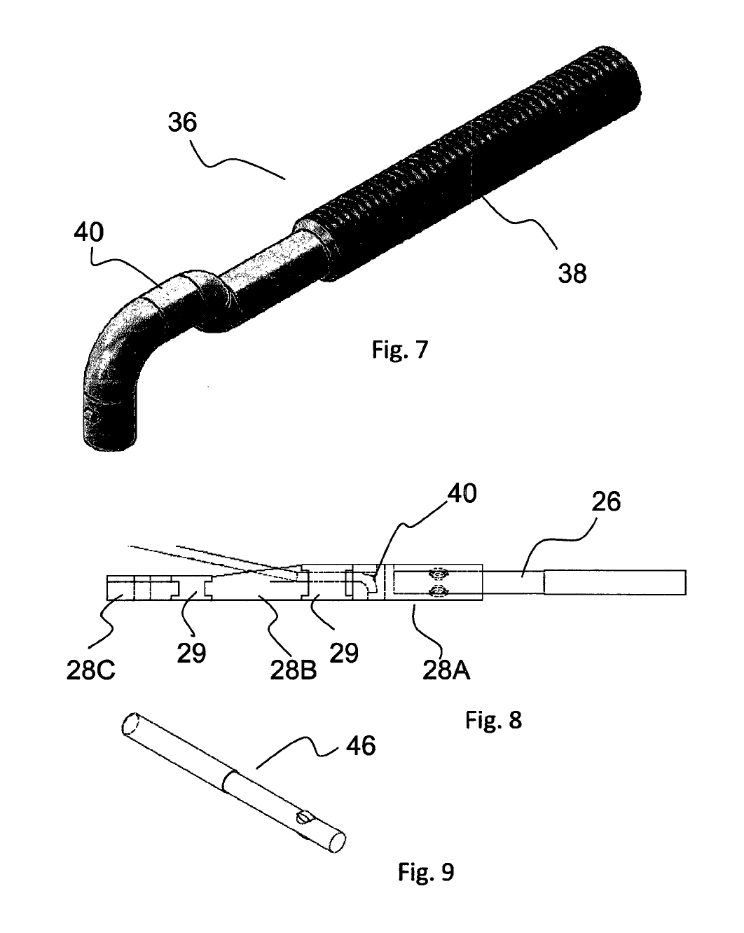

The lead rod 36 is shown in FIG. 7. The rod 36 comprises an elongate threaded portion 38 and a curved portion 40, which terminates with a generally U-shaped section. As can be seen in FIG. 8, the curved part 40 of the rod 36 extends into the groove 34 of the arm 16 and the tip extends between a gap 42 formed in the first section 28A of the arm 16 and against an abutment surface 44 to prevent the tip of the rod 36 from being accidentally extracted from the groove 34.

The threaded part 38 of the rod 36 receives a complimentary threaded part of a stainless steel connector rod 46, as can be seen in FIG. 9. The connector rod 46 then extends further into the housing channel 12 (as will be described later).

As movement is imparted to the arm 16 by the actuation button (left to right shown when referencing FIG. 2), the second section 28B of the arm 16 flexes downwardly (upwardly if the seal is used in the top of the door) due to the fact that the third section 28C remains in a fixed position secured to the sealing member 32. The rigidity of the main sections 28 of the arm 16 causes movement of the arm 16 to impart a vertical force to the sealing member 32. A tipping point is reached at which state the vertical movement occurs.

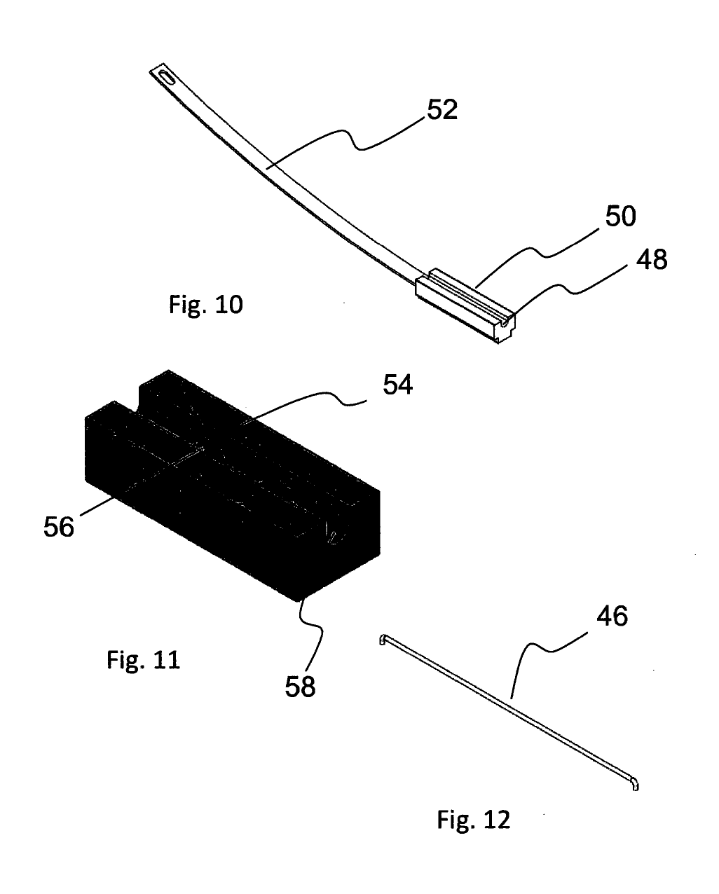

As can be seen in FIG. 2, the first connector rod 18 (or 46 if referring to FIG. 9) extends beyond the first drop arm 16 and through a recessed groove 48 formed in a fixed connector block (see FIG. 10) which is fixed in position within the channel 12 of housing 10 and provides a first spring assembly through connection to a spring member 14 (or 52 if referencing FIG. 10) that extends back from the connector block 50 to the sealing member 32 to which it is secured.

The spring member 14 or 52 acts to pull/push the sealing member back into the housing 10 once the actuator button is deactivated (i.e. un-depressed) which happens when the door is opened. When closed again, the actuator button causes the arm 16 to flex downwardly (as described above) which acts against the spring to force the sealing member 32 down.

Connector rods 18 (or 46 if referencing FIG. 12) extend through the channel 12 within the housing 10 all the way to a second drop arm 16B, as shown in FIGS. 1 and 2, which in the same way as the first drop arm 16A impart vertical force on the sealing member 32 at the location of the second drop arm 16B as well as on the first 16A. A plurality of connecting rods 18 or are interconnected through the assembly via rigid polypropylene connector blocks 54 (see FIG. 12). In the case of the embodiment shown in FIGS. 1 and 2, a first connector rod extends from the first drop arm 16A to the connector block 54 and a second connector rod extends from the connector block to the second drop arm 16B.

To this end, as can be seen in FIGS. 11 and 12 the ends of the connector rods 46 are curved so to be received within apertures in recessed grooves 58 formed along the connector block 54 allowing two connector rods 46 to be received into the connector block 54 at either end so to maintain longitudinal movement throughout the assembly of connector rods 46 all the way to the second drop arm 16B.

FIGS. 13 to 16 show end views, in cross section, of the sealing assembly.

FIG. 14 shows the profile of the housing 10. FIG. 15 illustrates the aluminium drop bar element 60 of the assembly.

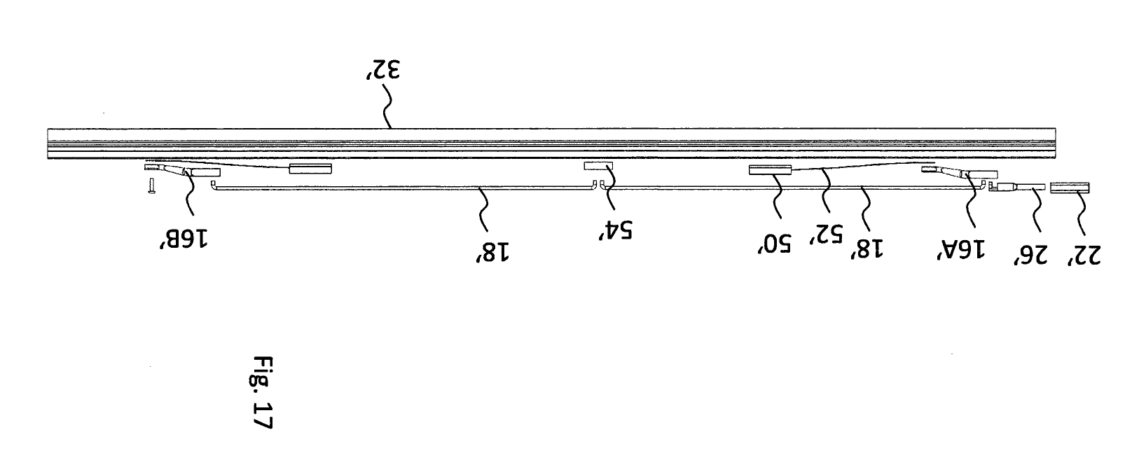

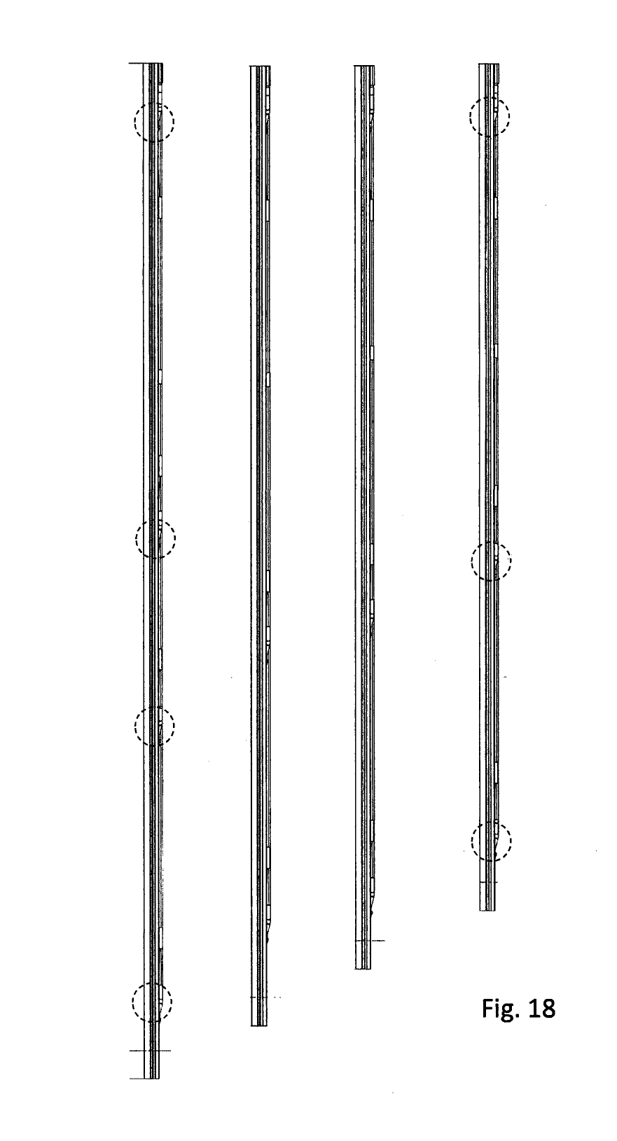

FIG. 16 shows the sealing member 32 in the form of an EPDM (Ethylene-propylene-diene or Ethylene-propylene) insert. It will be appreciated that any other suitable rubber or rubber like material or non-rubber like material, e.g. aluminium, may be used for the seal, and in various shapes

The vertical force exerted on the drop bar element 60 and hence the seal member 32 by the flexing of each drop arm 16 is sufficient to push and retain the sealing member 32 against the adjacent surface to provide an effective acoustic seal around that edge of the door. Unlike prior common place drop-down seals, the seal assembly of the present invention does not rely on gravity to extend downwardly across the gap between the door edge and the floor. Rather, a vertical force is exerted by movement of the arms 16 on closure of the door. As such, the seal assembly of the present invention would be just as applicable as, for example, use in the top edge of the door whereby flexing of the arms 16 imparts a vertical upward movement against the door threshold.

FIG. 17 is an exploded view of a second embodiment door seal in accordance with the invention, which may also be useful for understanding the arrangement of components for the first embodiment. Related components between the first and second embodiments are shown with like reference numerals, although in the case of the second embodiment these are marked with a (′) suffix.

In the case of both embodiments, the flexible sections 29 of the drop arms 16A, 16B are made from a TPE material advantageously selected so that it will melt in the event of a fire thereby fusing the rigid sections in their current position. Therefore, if the sealing member 32 is extended vertically with pressure being applied by the drop arms 16A, 16B, that position will be maintained by the fusing of the drop arms' flexible sections 29 due to the heat of the fire thereby providing resistance to smoke and heat.

The drop arms 16A, 16B can be injection moulded as a single piece assembly. The TPE joint connections allow the arm sections to bend while being extremely robust, making them difficult to tear or rip. The drop arms 16A, 16B provides greater flexibility allowing the downward (or upward) pressure of the sealing member 32 to compensate for uneven floors up to 6-7 mm. If compression of one flexible section is halted, the other flexible section can still compress to allow the arm to reach its desired depth. The flexible TPE joints allow the drop arms 16A, 16B to compress and stretch to allow for uneven floor conditions.

Although the above embodiments have been described in terms of two drop arms, it will be appreciated that further drop arms may be used to apply the necessary pressure to longer seal assemblies resulting in the lowering of the seal member across the seal. FIG. 18 shows an example whereby four assemblies of differing lengths are provided with different numbers of drop arms used (indicated by hashed circles).

It will be appreciated that the foregoing are merely an examples of embodiments and just some examples of their use. The skilled reader will readily understand that modifications can be made thereto without departing from the true scope of the inventions.

1. A sealing assembly for a hinged door which is pivotable over a door threshold when closed, the sealing assembly comprising:
a plurality of elements located within a channel positionable adjacent an edge of the door, the elements comprising:
an actuator responsive to closing of the door, the actuator comprising at least one connector rod extending along the channel and being movable longitudinally within the channel in response to the door closing, the or each rod being connected to at least one pivotable arm comprising rigid sections divided by flexible joints, the other end of the arm being connected to a sealing member, the or each arm being flexible such that as the or each connector rod moves along the channel, part of the arm flexes vertically thereby imparting and maintaining vertical pressure on the sealing member during use.

2. The assembly of claim 1, wherein the or each arm comprises at least one rigid section that comprises a recessed groove shaped so as to receive and retain a curved connector rod, which rod extends beyond the arm and is connected to a second arm.

3. The assembly of claim 2, wherein the connector rod is connected to the second arm by a first connector block which is connected to a further connector rod which is attached to the second arm.

4. The assembly of claim 1, further comprising:
a spring member that is connected to the sealing member at one part thereof and to a second connector block at a second part thereof, which second connector block is fixed in position within the channel, the spring member being configured to pull or push the sealing member back when the actuator is deactivated.

5. The assembly of claim 4, wherein the spring member is a leaf-type spring member, substantially planar in profile.

6. The assembly of claim 4, wherein the second connector block comprises a recessed groove through which the connector rod passes between the first and second arms.

7. The assembly of claim 1, wherein the or each arm comprises first, second and third rigid sections divided by first and second flexible joints, the first rigid section being connected to the actuator and the third rigid section being connected to the sealing member.

8. The assembly of claim 1, wherein each rigid section of the arm is formed of polypropylene.

9. The assembly of claim 1, wherein the or each flexible section of the arm is formed of TPE.

10. A sealing assembly for a hinged door which is pivotable over a door threshold when closed, the sealing assembly comprising:
a plurality of elements located within a channel positionable adjacent an edge of the door, the elements comprising:
an actuator which mechanically moves responsive to closing of the door, the actuator comprising a first connector rod extending along the channel and being movable longitudinally within the channel, the first connector rod being connected to a drop arm comprising first, second and third substantially rigid sections divided by first and second flexible joints, the first rigid section being connected to the first connector rod and the third rigid section being connected to a sealing member, the drop arm being configured to flex at one or both flexible joint(s) as the first connector rod moves along the channel in order to impart and maintain a vertical force on the sealing member in use, and wherein a spring member is provided which is connected to the sealing member at one part thereof and to a fixed connector block within the channel at another part thereof in such a way as to pull/push the sealing member backwards into the channel when the actuator is deactivated.
